(19) United States
(12) Patent Application Publication
(10) Pub. No.: US 2015/0280488 A1
(43) Pub. Date: Oct. 1, 2015

(54) SYSTEMS, METHODS, AND DEVICES FOR OPTICAL WIRELESS CHARGING

(71) Applicant: QUALCOMM Incorporated, San Diego, CA (US)

(72) Inventors: John Michael Wyrwas, Mountain View, CA (US); Shahin Farahani, San Diego, CA (US); Evgeni Petrovich Gousev, Saratoga, CA (US); Russell Wayne Gruhlke, Milpitas, CA (US); Rashid Ahmed Akbar Attar, San Diego, CA (US)

(21) Appl. No.: 14/487,549

(22) Filed: Sep. 16, 2014

Related U.S. Application Data
(60) Provisional application No. 61/970,801, filed on Mar. 26, 2014.

(51) Int. Cl. H02J 7/35

(52) U.S. Cl. CPC H02J 7/35

(57) ABSTRACT

A system and method for wirelessly charging a chargeable device is provided. In one aspect, the method includes detecting a presence of a chargeable device within a charging region of the optical charger. The method further includes providing light to the chargeable device upon detecting the presence of the chargeable device within the charging region. The light provided through an optical casing and an elastomer when the chargeable device is in contact with the elastomer. The optical casing optically coupled to the elastomer. The light sufficient to charge or power the chargeable device and spectrally matched to a bandgap of an optical receiver positioned on the chargeable device.

### CROSS REFERENCE TO RELATED APPLICATIONS

This application claims priority under 35 U.S.C. §119(e) to U.S. Provisional Patent Application No. 61/970,801 entitled “SYSTEMS, METHODS, AND DEVICES FOR OPTICAL WIRELESS CHARGING” filed on Mar. 26, 2014 the disclosure of which is hereby incorporated by reference in its entirety.

### FIELD

The present invention relates generally to wireless power. More specifically, the disclosure is directed to systems, methods, and devices for optical wireless charging between a wireless power receiver and a wireless power transmitter.

### BACKGROUND

An increasing number and variety of electronic devices are powered via rechargeable batteries. Such devices include mobile phones, portable music players, laptop computers, tablet computers, computer peripheral devices, communication devices (e.g., Bluetooth devices), digital cameras, hearing aids, and the like. While battery technology has improved, battery-powered electronic devices increasingly require and consume greater amounts of power, thereby often requiring recharging. Rechargeable devices are often charged via wired connections through cables or other similar connectors that are physically connected to a power supply. Cables and similar connectors may sometimes be inconvenient or cumbersome and have other drawbacks. Wireless charging systems that are capable of transferring power in free space to be used to charge rechargeable electronic devices or provide power to electronic devices may overcome some of the deficiencies of wired charging solutions. As such, wireless power transfer systems and methods that efficiently and safely transfer power to electronic devices are desirable.

### SUMMARY

Various implementations of systems, methods and devices within the scope of the appended claims each have several aspects, no single one of which is solely responsible for the desirable attributes described herein. Without limiting the scope of the appended claims, some prominent features are described herein.

Details of one or more implementations of the subject matter described in this specification are set forth in the accompanying drawings and the description below. Other features, aspects, and advantages will become apparent from the description, the drawings, and the claims. Note that the relative dimensions of the following figures may not be drawn to scale.

One aspect of the disclosure provides an optical charger for wirelessly charging a chargeable device. The optical charger includes a light source configured to provide light to the chargeable device sufficient to charge or power the chargeable device, the light spectrally matched to a bandgap of an optical receiver positioned on the chargeable device. The optical charger further includes an optical casing at least partially surrounding the light source. The optical charger further includes an elastomer situated on the optical casing such that the elastomer is located between the optical casing and the chargeable device when charging.

Another aspect of the disclosure provides a method for providing wireless power from an optical charger. The method includes providing light to a chargeable device through an optical casing and an elastomer when the chargeable device is in contact with the elastomer. The optical casing is optically coupled to the elastomer. The light is sufficient to charge or power the chargeable device and spectrally matched to a bandgap of an optical receiver positioned on the chargeable device.

Another aspect of the disclosure provides an apparatus for wirelessly charging a chargeable device. The apparatus includes means for providing light to the chargeable device sufficient to charge or power the chargeable device. The light spectrally matched to a bandgap of an optical receiving means positioned on the chargeable device. The apparatus further includes means for coupling the providing means with the chargeable device.

Another aspect of the disclosure provides an apparatus for receiving wireless power. The apparatus includes a photovoltaic cell configured to receive light from an optical charger, the light spectrally matched to a bandgap of the photovoltaic cell. The apparatus further includes an optical filter coupled to the photovoltaic cell configured to filter wavelengths in a visible spectrum.

Another aspect of the disclosure provides a method for receiving wireless power from an optical charger. The method includes receiving light from the optical charger, the light spectrally matched to a bandgap of an optical receiver. The method further includes filtering wavelengths of the light in a visible spectrum.

Another aspect of the disclosure provides an apparatus for receiving wireless power. The apparatus includes means for receiving light from an optical charger, the light spectrally matched to a bandgap of the receiving means. The apparatus further includes means for filtering wavelengths of the light in a visible spectrum.

### BRIEF DESCRIPTION OF THE DRAWINGS

FIG. 1 is a functional block diagram of an exemplary wireless power transfer system, in accordance with exemplary embodiments described herein.

FIG. 2A is an illustration of an exemplary wireless power receiver.

FIG. 2B is a diagram of an exemplary wireless power transfer system, in accordance with exemplary embodiments described herein.

FIG. 2C is a diagram of an exemplary wireless power transfer system, in accordance with exemplary embodiments described herein.

FIG. 2D is a chart illustrating an exemplary optical charger efficiency.

FIG. 3A is a top view diagram of an exemplary wireless power transfer system, in accordance with exemplary embodiments described herein.

FIG. 3B is a side view diagram of an exemplary wireless power transfer system, in accordance with exemplary embodiments described herein.

FIG. 4 is a side view diagram of an exemplary wireless power transfer system, in accordance with exemplary embodiments described herein.

FIG. 5 is a cross-sectional view diagram of an exemplary wireless power transfer system, in accordance with exemplary embodiments described herein.

FIG. 6 is a diagram of an exemplary wireless power transfer system, in accordance with exemplary embodiments described herein.

FIG. 7 is a diagram of an exemplary wireless power transfer system, in accordance with exemplary embodiments described herein.

FIG. 8 is a diagram of an exemplary wireless power transfer system, in accordance with exemplary embodiments described herein.

FIG. 9 is a series of charts of exemplary optical charging curves for charging the battery using a gallium arsenide (GaAs) photovoltaic cell.

FIG. 10A is a graph representing the transmission percentage of gentex filtron at different wavelengths and another graph representing the optical density of gentex filtron at different wavelengths

FIG. 10B is a graph representing the observed film property of perylene black at different wavelengths.

FIG. 10C is a graph representing the observed film property of cobalt aluminate blue spinel at different wavelengths.

FIG. 10D is a graph representing the observed film property of cadmium orange at different wavelengths.

FIG. 11 is a flowchart of an exemplary method of wirelessly charging a chargeable device, in accordance with exemplary embodiments described herein.

FIG. 12 is a functional block diagram of an apparatus for providing wireless power, in accordance with certain embodiments described herein.

The various features illustrated in the drawings may not be drawn to scale. Accordingly, the dimensions of the various features may be arbitrarily expanded or reduced for clarity. In addition, some of the drawings may not depict all of the components of a given system, method or device. Finally, like reference numerals may be used to denote like features throughout the specification and figures.

### DETAILED DESCRIPTION

The detailed description set forth below in connection with the appended drawings is intended as a description of exemplary embodiments of the invention and is not intended to represent the only embodiments in which the invention may be practiced. The term “exemplary” used throughout this description means “serving as an example, instance, or illustration,” and should not necessarily be construed as preferred or advantageous over other exemplary embodiments. The detailed description includes specific details for the purpose of providing a thorough understanding of the exemplary embodiments of the invention. In some instances, some devices are shown in block diagram form.

Wirelessly transferring power may refer to transferring any form of energy associated with light, electric fields, magnetic fields, electromagnetic fields, or otherwise from a transmitter to a receiver without the use of physical electrical conductors (e.g., power may be transferred through free space). The power output may comprise a light from a light source that may be received, captured by, or absorbed by a photovoltaic (PV) cell which is then converted into electrical power to achieve power transfer.

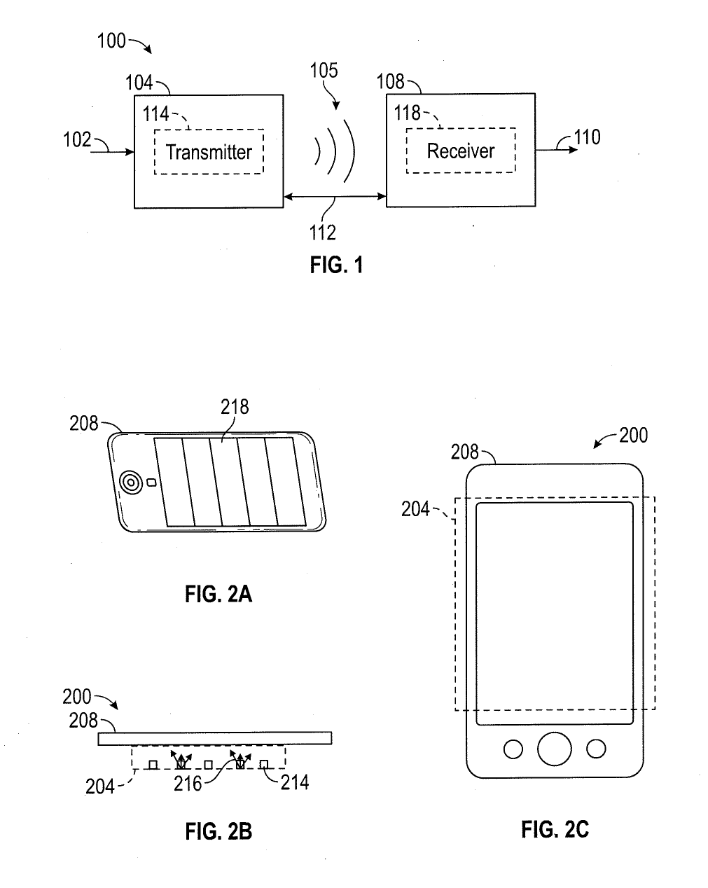

FIG. 1 is a functional block diagram of an exemplary wireless power transfer system 100, in accordance with exemplary embodiments of the invention. Input power 102 may be provided to a transmitter 104 from a power source (not shown) for generating a light output 105 for providing energy transfer. A receiver 108 may absorb the light 105 and generate output power 110 for storing or consumption by a device (not shown) coupled to the output power 110. Both the transmitter 104 and the receiver 108 are separated by a distance 112. In one exemplary embodiment, transmitter 104 and receiver 108 are configured according to a mutual spectral matching. When a bandgap of receiver 108 and a bandgap of transmitter 104 are substantially the same or very close, transmission losses between the transmitter 104 and the receiver 108 are minimal. The bandgap of the receiver 108 may determine what portion of the light spectrum is most efficiently converted to electrical power by the receiver. As such, wireless power transfer may be provided over larger distance in contrast to purely inductive solutions that may require large coils to be very close (e.g., mms).

The receiver 108 may receive power when the receiver 108 is located within a distance 112 to receive the light 105 produced by the transmitter 104. The transmitter 104 may include a light source 114 for outputting an energy transmission. The receiver 108 further includes a photovoltaic cell or a photodiode 118 for receiving or capturing energy from the energy transmission. The light source 114 and the photovoltaic cell 118 may be sized according to applications and devices to be associated therewith. As described above, efficient energy transfer may occur by spectrally matching the bandgap of the light source 114 to the photovoltaic cell 118 rather than propagating most of the energy in frequencies or wavelengths outside the respective bandgaps or heat. The bandgap of the photovoltaic cell 118 may determine what portion of the electromagnetic spectrum the photovoltaic cell 118 absorbs most efficiently. Spectral matching may comprise providing light from the light source 114 at a wavelength that matches, or is within, the wavelength spectrum that the photovoltaic cell 118 efficiently absorbs. Different photovoltaic cells may comprise materials that have different corresponding bandgaps. Accordingly, in some embodiments, efficiency energy transfer may occur when the light source 114 and the photovoltaic cell 118 are made of the same material.

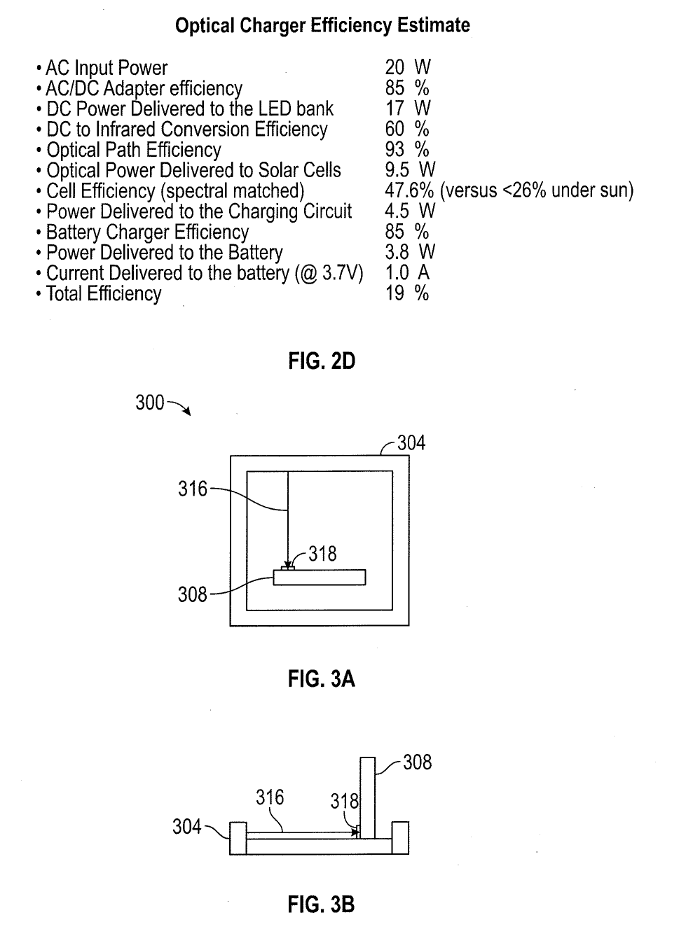

FIG. 2A is a diagram of a portable device 208, in accordance with various exemplary embodiments of the invention. The portable device 208 may include devices such as mobile phones, watches, portable music players, laptop computers, tablet computers, computer peripheral devices, communication devices (e.g., Bluetooth devices), digital cameras, hearing aids (any other medical devices), and the like. In some embodiments, the portable device 208 may comprise the receiver 108 of FIG. 1. In some embodiments, the portable device 208 may comprise an optical receiver 218. In some embodiments, the optical receiver 218 may be integrated on the body of the portable device or on a removable skin or case. In some embodiments, the optical receiver 218 may comprise a photovoltaic cell. In some embodiments, the photovoltaic cell may comprise a thin film gallium arsenide (GaAs) photovoltaic cell. This thin film may enable a small form factor, light weight, flexibility, and high efficiency. In some embodiments, the photovoltaic cell may comprise monocrystalline silicon, polycrystalline silicon, amorphous silicon, cadmium telluride, copper indium gallium selenide/sulfide, or other possible materials for photovoltaic cells. In some embodiments, the optical receiver 218 may be optimized (e.g. by choices of electrode films) to operate efficiently under high light intensities and high current densities that are substantially larger (e.g., more than two times) than what it would be exposed to under direct sunlight illumination. In addition to being used in the wireless charging system 200 (described below), the optical receiver may also be used for energy scavenging of a broadband light source, such as a room light or sunlight, to trickle-charge the battery of the portable device 208. Table 1 below shows a table of estimated energy scavenged. In some embodiments, the optical receiver 218 may have an efficiency greater than twenty percent for the broadband light source as the values in the table are shown for illustration purposes only.

TABLE 1
Energy Scavenging Estimate

| | Area: | |
|---|---|---|
| | 1 square inch | 6 square inches |
| | Milliamp- | Milliamp- |
| | hours @ 4.5 V | hours @ 4.5 V |
| 6 hours indirect sun (50k lux) | 93 | 636 |
| 6 hours office white LED lighting | 1.1 | 7.4 |
| (1k lux) | | |
| 6 hours home incandescent | 0.35 | 2.40 |
| lighting (100 lux) | | |

FIG. 2B is a side view diagram of a wireless charging system 200 comprising of a portable device 208 and an optical charging device 204, in accordance with various exemplary embodiments of the invention. In some embodiments, the optical charging device 204 may comprise a light source 214. In some embodiments, the light source 214 may comprise a light-emitting diode (LED). In some embodiments, the light source 214 may comprise a laser or other light source. The light source 214 may emit a light beam 216 for charging the portable device 208. In some aspects, an electro-optical efficiency of the light source 214 is greater than forty percent. FIG. 2C is an overhead view of the wireless charging system 200 of FIG. 2B, in accordance with various exemplary embodiments of the invention. In some embodiments, the size of the optical charging device 204 may be larger than the optical receiver 218. In some embodiments, the size of the optical charging device 204 may be the same size or smaller than the optical receiver 218.

Certain devices utilize solar power or ambient room lighting to charge or power the device or battery of the device. However, efficiency under sunlight or ambient room lighting may be too low for certain portable devices to function properly. Certain embodiments disclosed herein relate to high-efficiency wireless optical charging. High-efficiency wireless optical charging may operate with efficiency comparable to existing inductive based wireless charging systems. FIG. 2D is a table showing an exemplary efficiency estimate of the wireless charging system 200. The values illustrated in FIG. 2D, are exemplary only to illustrate different stages in optical charging and in some embodiments higher efficiencies for some or all the values illustrated in FIG. 2D are possible. High-efficiency wireless optical charging may also offer several advantages over inductive wireless charging. For example, receiving coils for inductive or capacitive coupling may add thickness and weight to a portable device 208 while optical receiver photovoltaic cells (such as the optical receiver 218) may be thinner and lighter than such coils. Additionally, coils and plates used in inductive coupling may complicate the electrical and radio component placement and shielding for the portable device while the optical charging system would not produce electromagnetic interference. Moreover, inductive charging may require the portable device 208 to include an alternating current to direct current (AC/DC) converter on the portable device, which adds additional components and cost, while the portable device 208 using optical charging provides DC output and therefore would not require the AC/DC converter.

FIG. 3A is a top view diagram of an interaction of a portable device 308 and an optical charging device 304. In some embodiments, the optical charging device may be similar to the optical charging device 104 and 204. In some embodiments, the portable device 308 may comprise a wearable portable device such as a watch or bracelet. The portable device 308 may be similar to the portable device 108 and 208. In some embodiments, the portable device 308 may comprise a photovoltaic cell strip 318 that may be located on a portion of the front or back surface of the portable device 308. In some embodiments, the photovoltaic cell strip 318 may comprise a thin film gallium arsenide (GaAs) photovoltaic cell. In some embodiments, the portable device 308 may be positioned on the optical charging device 304 such that the photovoltaic strip 318 is capable of receiving an optical beam 316 provided by the optical charging device 304. In some embodiments, the optical charging device 304 may be configured such that it provides the optical beam 316 which is spectrally matched to the bandgap of the photovoltaic cell strip 318. For example, an array of 850 nm nominal wavelength LEDs may be arranged in a grid that is approximately the same size and shape as the photovoltaic cell strip 318. In some embodiments, the optical charging device 304 may be opto-mechanically configured to efficiently transfer light to the photovoltaic strip 318 (e.g., focus the optical beam 316 on the photovoltaic strip 318). FIG. 3B is a side view diagram of an interaction of the portable device 308 and the optical charging device 304 of FIG. 3A, in accordance with various exemplary embodiments of the invention.

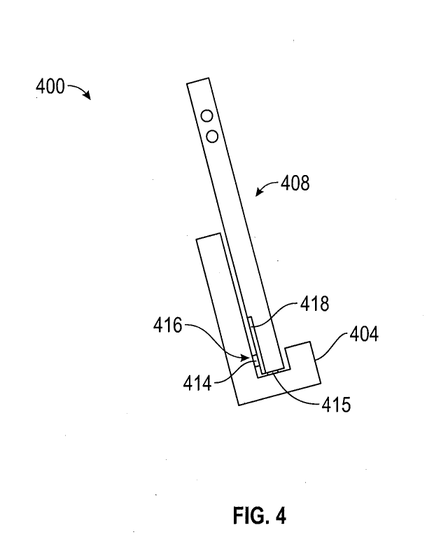

FIG. 4 is a side view diagram of a wireless charging system 400 comprising a portable device 408 and an optical charging device 404. In some embodiments, the portable device 408 may comprise a photovoltaic cell 418 that may be located on a portion of the front or back surface of the portable device 408. In some embodiments, the photovoltaic cell 418 may comprise a thin film gallium arsenide (GaAs) photovoltaic cell. In some embodiments, the portable device 408 may be positioned on the optical charging device 404 such that the photovoltaic strip 418 is capable of receiving an optical beam 416 provided by the optical charging device 404. As shown in FIG. 4, the optical charging device 404 may comprise a stand on which a user places the portable device 408. In some embodiments, the optical charging device 404 may include a mechanical snap-in mechanism 415 which may turn the optical charging device 404 on. In some embodiments, the mechanical snap-in mechanism 415 may be replaced by a motion or weight sensor or other configuration which determines that the portable device 408 is in the proper position for charging and which may turn on the optical charging device 404. The optical charging device 404 may comprise a light source 414. In some aspects, the light source 414 may be configured such that it provides the optical beam 416 which is spectrally matched to the bandgap of the photovoltaic cell strip 418. For example, an array of 850 nm nominal wavelength LEDs may be arranged in a grid that is approximately the same size and shape as the photovoltaic cell strip 418. In some embodiments, the optical charging device 404 may be opto-mechanically configured to efficiently transfer light to the photovoltaic strip 418 (e.g., focus the optical beam 416 on the photovoltaic strip 418.)

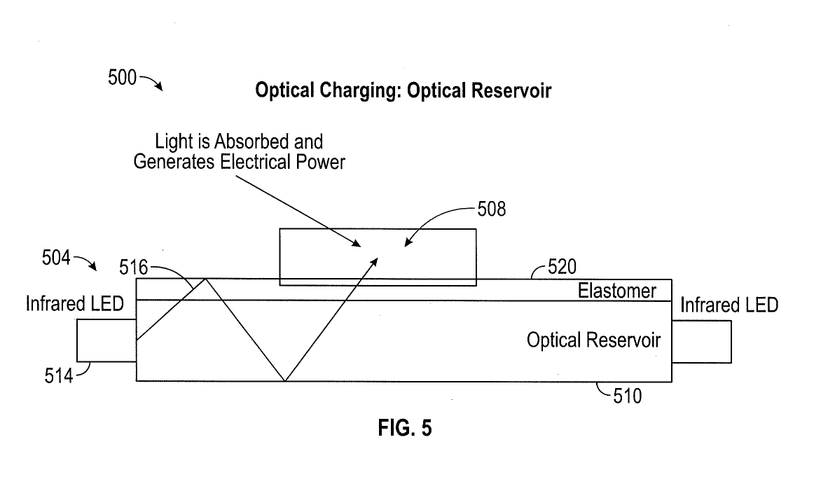

FIG. 5 is a cross-sectional view diagram of a wireless charging system 500 comprising a portable device 508 and an optical charging device 504. In some embodiments, the optical charging device 504 may comprise an optical reservoir 510 or light guide that is edge coupled to a light source 514. In some embodiments, the light source 514 may comprise an infrared LED. The optical reservoir 510 or light guide may be configured such that light beams 516 from the light source 514 cannot escape the optical reservoir 510. In this configuration a light beam 516 may reflect at the optical reservoir 510 edges either by total internal reflection (TIR) from a glass/air interface or from a high reflectivity mirror placed there. In some embodiments, the optical charging device 504 may also comprise an elastomer layer 520 placed on the surface of the optical reservoir 510 or the light guide and optically couples to the optical reservoir 510. In some aspects, the elastomer layer 520 may have a similar index of refraction as the optical reservoir 510 such that the light beam 516 may reflect at the elastomer layer 520 edges by TIR from an elastomer/air interface. In some aspects, the index of refraction may be between 1.35-1.7. In some aspects, the elastomer layer 520 conforms to the surface of both the optical reservoir 510 and any object placed on it, such as the portable device 508.

In some embodiments, the portable device 508 may comprise a photovoltaic cell that may be located on a portion of the front or back surface of the portable device 508. In some embodiments, the photovoltaic cell may comprise a thin film gallium arsenide (GaAs) photovoltaic cell.

As shown in FIG. 5, the portable device 508 is placed on the optical charging device 504. The light source 514 may emit a light beam 516 which then travels through the optical reservoir 510 to the elastomer layer 520. The light beam 516 then travels through the elastomer layer 520 until it reaches the edge of the elastomer layer 520. At the edge of the elastomer layer 520, the light beam 516 reflects back through the elastomer layer 520 by TIR from the elastomer/air interface. The light beam 516 then passes through the elastomer layer 520 to the optical reservoir 510. The light beam then reaches the edge of the optical reservoir 510 and reflects back through the optical reservoir 510 by TIR from a glass/air interface or from a high reflectivity mirror placed there. The light beam 516 the travels through the optical reservoir 510 to the elastomer layer 520. The light beam 516 then reaches the interface of the elastomer layer 520 and the portable device 508. At locations where the elastomer layer 520 conforms to the portable device 508 substantially without air gaps, the light beam 516 can escape the reservoir/elastomer structure (e.g., the optical charging device 504) via frustrated TIR. The light beam 516 then propagates into the portable device 508 and is collected/converted into electrical energy by the photovoltaic cell.

The configuration of the wireless charging system 500 may offer several advantages. For example, there may be minimal eye safety issues because the light beam 516 remains confined in the optical reservoir 510 and elastomer layer 520 until the portable device 508 is placed on the optical charging device 504. When the portable device 508 is placed on the optical charging device 504, the portable device 508 absorbs the light beam 516 so the light beam 516 does not escape through other pathways. Additionally, position sensing for the optical charging device 504 may not be required because the size of the portable device 508 dictates where the light beam 516 is extracted. Moreover, the optical charging device 504 may utilize LEDs instead of lasers which may further reduce eye safety issues. Furthermore, some light that is not absorbed by the device photovoltaic cell may be reflected back into the reservoir and therefore would be effectively recycled.

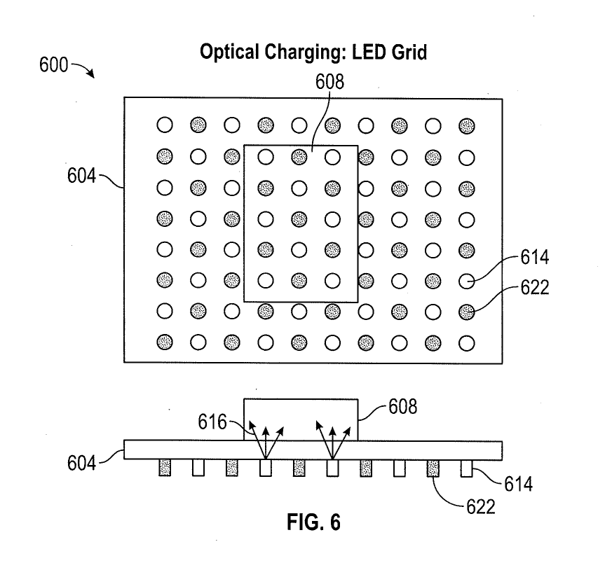

FIG. 6 is a top view and side view diagram of a wireless charging system 600 comprising a portable device 608 and an optical charging device 604. In some embodiments, the optical charging device 604 may comprise a light source 614 and a sensor 622 encased in a transparent substrate. The transparent substrate may comprise any material that allows light to pass through. The light source 614 may comprise an infrared LED and the light source 614 may emit a light beam 616. The sensor 622 may comprise a motion sensor, weight sensor, or other sensor to indicate the position/orientation of the portable device 608. In some embodiments, the portable device 608 may comprise a photovoltaic cell that may be located on a portion of the front or back surface of the portable device 608. In some embodiments, the photovoltaic cell may comprise a thin film gallium arsenide (GaAs) photovoltaic cell.

As shown in FIG. 6, when the portable device 608 is placed on the optical charging device 604, the sensors 622 indicate the position/orientation of the portable device 608. The sensors 622 may indicate the position/orientation of the portable device 608 by measuring the shadow produced by the portable device 608 blocking ambient light. Alternatively, the light sources 614 may emit light beams 616 periodically to probe the space above the portable device 608 and reflection from the portable device 608 may be sensed to determine the position/orientation of the portable device 608. When the optical charging device 604 determines the location portable device 608, light sources 614 directly underneath the portable device 608 may be turned on and emit light beams 616.

The grid configuration of the wireless charging system 600 may offer several advantages. For example, by turning on light sources 614 (e.g., LEDs) directly under the portable device 608 there may be an efficient transfer of the light beams 616 to the photovoltaic cells of the portable device 608. Additionally, selectively emitting light beams 616 only from light sources directly underneath the portable device 608 may also reduce eye safety risks.

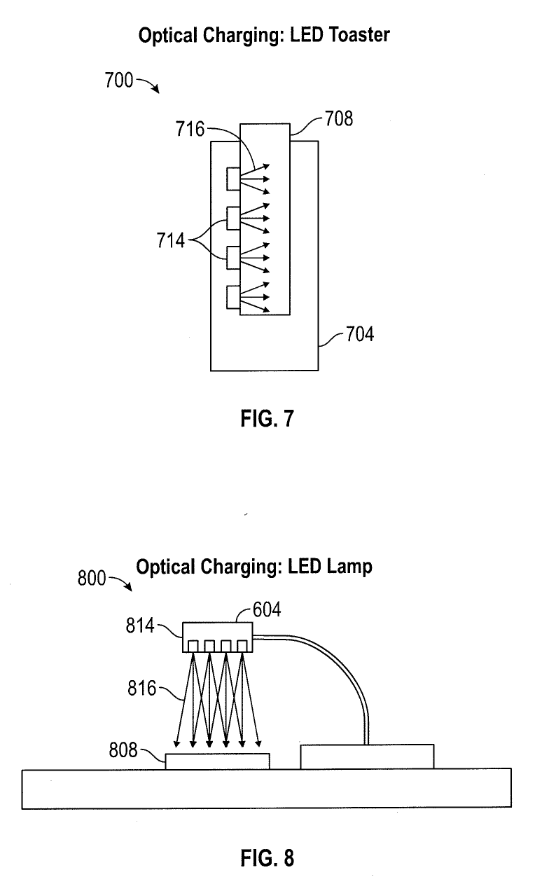

FIG. 7 is a side view diagram of a wireless charging system 700 comprising a portable device 708 and an optical charging device 704. In some embodiments, the optical charging device 704 may be a toaster shape that may comprise a light source 714 placed on one or more sides of the interior of the optical charging device 704. The light source 714 may comprise an infrared LED and the light source 714 may emit a light beam 716. In some embodiments, the portable device 708 may comprise a photovoltaic cell that may be located on a portion of the front or back surface of the portable device 708. In some embodiments, the photovoltaic cell may comprise a thin film gallium arsenide (GaAs) photovoltaic cell.

As shown in FIG. 7, the portable device 708 may be placed within the optical charging device 704 with the photovoltaic cell facing the light sources 714, similar to placing a slice of bread in a toaster. The placement of the portable device 708 within the optical charging device 704 may be detected by a pressure or motion detector which may then trigger the light sources 714 to emit light beams 716 to charge the portable device 708. The light beams 716 may be efficiently coupled into the photovoltaic cell as described above, through spectral matching of the respective bandgaps.

The toaster configuration of the wireless charging system 700 may offer several advantages. For example, the configuration allows for very efficient optical coupling because the portable device 708 is placed in very close proximity to the light source 716 and the size and shape of the optical charging device 704 may be configured to efficiently couple to the portable device 708. Moreover, because the light beams are confined to the interior of the toaster configuration of the optical charging device 704, eye safety may not be an issue.

FIG. 8 is a side view diagram of a wireless charging system 800 comprising a portable device 808 and an optical charging device 804. In some embodiments, the optical charging device 804 may comprise a light source 814 placed into a lamp fixture or overhead lighting. The light source 814 may comprise collimated infrared LEDs and the light source 814 may emit a light beam 816. In some embodiments, visible light sources 814 may be placed in the same fixture to provide targeting for the optical charging device 804. In some embodiments, the portable device 808 may comprise a photovoltaic cell that may be located on a portion of the front or back surface of the portable device 808. In some embodiments, the photovoltaic cell may comprise a thin film gallium arsenide (GaAs) photovoltaic cell.

As shown in FIG. 8, the portable device 808 may be placed on a table or surface and the optical charging device 804 may be placed above the portable device 808 with the light source 814 facing the portable device 808. In some embodiments, the portable device 808 is placed near the lamp and the optical charging device 804 is positioned to illuminate the portable device 808 with the visible targeting light. This positioning may help ensure that the portable device 808 intercepts the charging, infrared light.

The lamp configuration of the wireless charging system 800 may offer several advantages. The lamp configuration may allow for flexible charging options. For example, collimated infrared light sources 814 may be placed in overhead light fixtures above a conference table and multiple portable devices 808 may then be placed on the visible targeting spots on the table for remote charging. Additionally, low losses in free space light propagation may enable efficient optical charging. Moreover, remote charging is possible using collimated light.

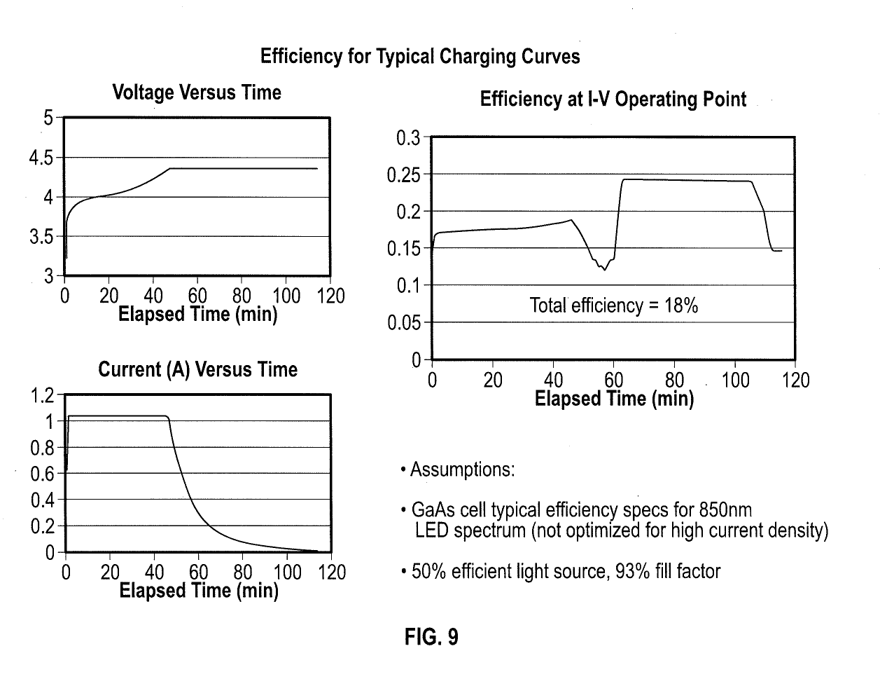

For the wireless charging systems 300-800 in FIGS. 3A-8, the wireless charging system may also comprise a communication channel from the portable device (e.g., 308, 408, 508, 608, 708, or 808) to the optical charging device (e.g., 304, 404, 504, 604, 704, or 804) which notifies the optical charging device of the present voltage level or charge state of a battery of the portable device. In response, the optical charging device adjusts the light intensity that it emits, thus adjusting the amount of current reaching the battery at that time. The wireless communication channel may comprise any wireless communication channel (e.g., over Bluetooth, radio frequency (RF), zigbee, cellular, wireless local area network (WLAN), using the optical proximity sensor of the portable device to send data, etc.). The optical charging device may adjust/shape its current output based on the charge level of the battery as it is being charged, in order to support faster charging or to prolong the lifetime of the battery. FIG. 9 is a graph of exemplary optical charging curves for charging the battery using a GaAs photovoltaic cell.

For the wireless charging systems 300-800 in FIGS. 3A-8, the wireless charging system may also comprise a detection circuit to detect whether the portable device is located in a charging region of the optical charging device.

In some embodiments, the detection circuit may comprise a magnetic sensor (Hall effect, magnetic compass, etc.) in the optical charging device, and an arrangement of magnets on the portable device. The magnetic sensor may detect the magnetic fields from the magnets of the portable device and indicate whether the portable device is within the charging region of the optical charging device. The magnets may also serve a dual purpose of aligning and holding the portable device onto the optical charging device.

In some embodiments, the detection circuit may comprise a pressure sensor or mechanical switch on the optical charging device (e.g., the mechanical snap of FIG. 4 or pressure sensor of FIG. 7. In other aspects, the detection circuit may comprise a “pump” light source and light sensor on the optical charging device, and a matched fluorescent pigment on the portable device. The optical charging device periodically probes with the pump light source to detect the presence of the fluorescence reflected back (e.g., similar to the periodic probing described above with respect to FIG. 6). Additionally, the detection circuit may comprise an optical reflectance or transmission sensor on the optical charging device.

In some embodiments, the detection circuit may comprise a wireless beacon (such as a Bluetooth low energy beacon) in the optical charging device or portable device that determines the distance between the optical charging device and the portable device. In some embodiments, the detection circuit may comprise a camera and machine vision logic on the optical charging device, which detects the presence of a feature (e.g., quick response (QR) code, physical characteristics of the portable device, or pattern displayed on the device's display) on the portable device. In some embodiments, the detection circuit may comprise a camera and machine vision logic on the portable device, which detects the presence of a feature (e.g., quick response (QR) code, physical characteristics of the optical charging device, or pattern displayed on the optical charging device's display) on the optical charging device and where the portable device communicates wirelessly to the optical charging device (e.g., Bluetooth) to begin the charging. Any of the above exemplary detection circuits may be implemented alone or in combination to detect the presence of the portable device within the charging region of the optical charging device. The detection circuits/systems described above may further be integrated into a variety of different types of wireless charging systems in addition to those optical systems described above (e.g., inductive using primary and secondary coils for transferring power, ultrasound systems, and the like).

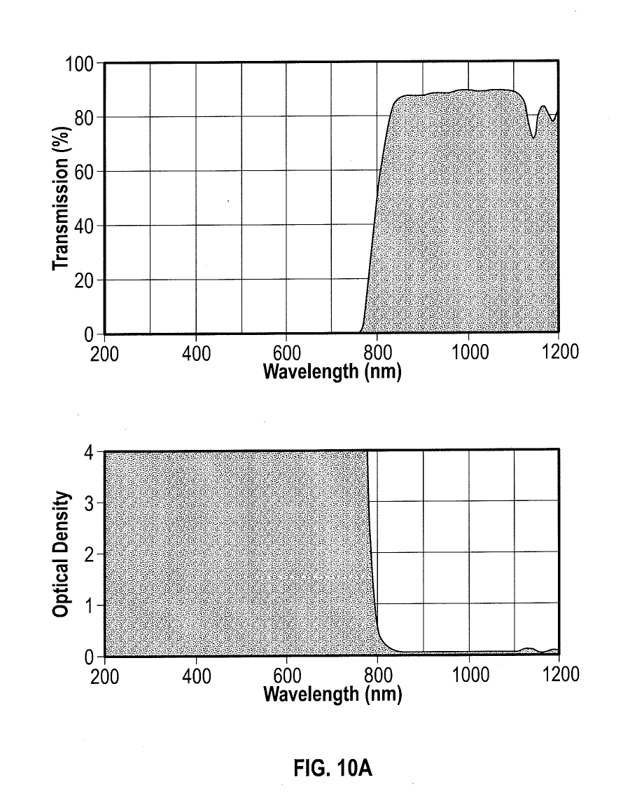

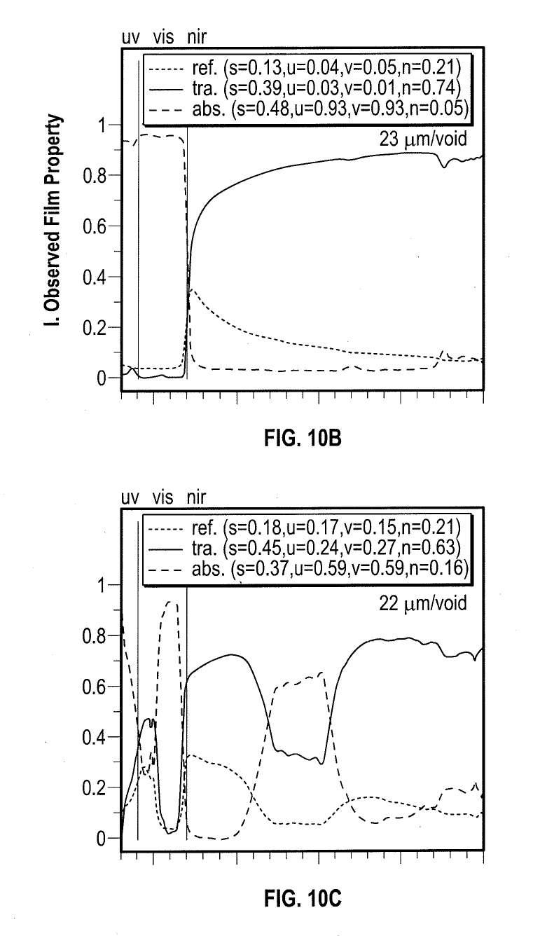

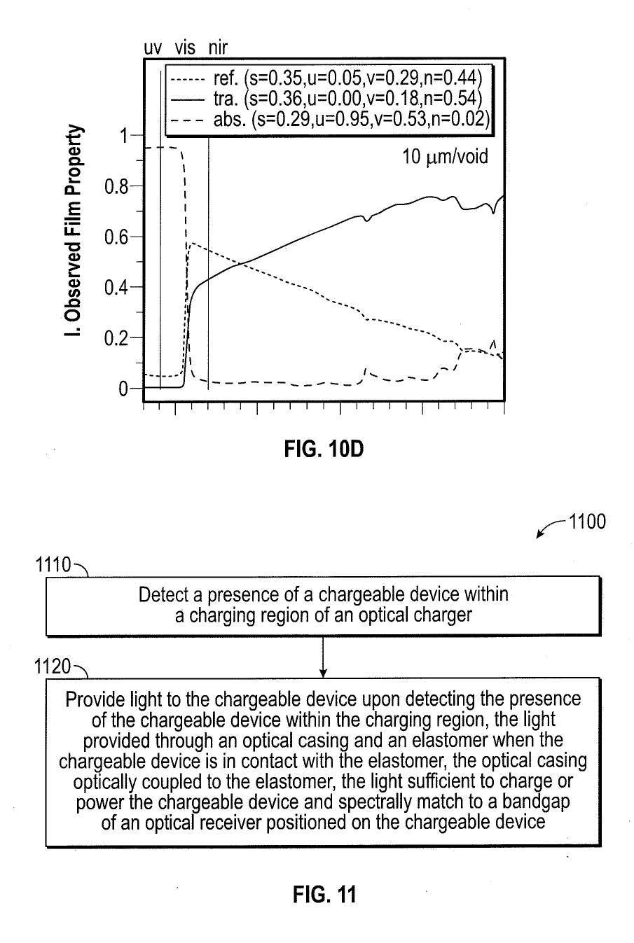

The portable device 108, 208, 308, 408, 508, 608, 708, and 808 of FIGS. 1-8 may also comprise a window material that may be placed over the photovoltaic cell 118, 318, 418 and the optical receiver 218 of FIGS. 1-4. The window material may comprise material that is substantially transparent to the wavelength span of light that is produced by the optical charging device, while appearing an opaque or translucent color to visible light. In some embodiments, the window material may comprise a filter that filters visible light and allows infrared light to pass through and charge the portable device. By filtering the visible light, the window material may appear opaque or a translucent color. The coloring of the window material may be due to pigments or structural coloring, either on a separate substrate or as a coating. For example, the window material may comprise gentex filtron (a proprietary dye) in which visibly “black” absorptive dyes are dispersed in polycarbonate or acrylic. Gentex giltron may be advantageously and conventionally molded and extruded into any shape. One feature of gentex filtron is that it may allow high transmissions at wavelengths greater than 800 nm. FIG. 10A is a graph representing the transmission percentage of gentex filtron at different wavelengths and another graph representing the optical density of gentex filtron at different wavelengths. In another embodiment, the window material may comprise perylene black (an organic pigment) which would appear black at visible light wavelengths and would allow high transmission at wavelengths greater than 750 nm. FIG. 10B is a graph representing the observed film property of perylene black at different wavelengths. In another embodiment, window material may comprise cobalt aluminate blue spinel (an inorganic pigment) which would appear blue at visible light wavelengths and would have very low absorption at wavelengths between 700 and 900 nm. FIG. 10C is a graph representing the observed film property of cobalt aluminate blue spinel at different wavelengths. In another embodiment, window material may comprise cadmium orange (an inorganic pigment) which would appear orange at visible light wavelengths and would have very low absorption at wavelengths between 700 and 900 nm. FIG. 10D is a graph representing the observed film property of cadmium orange at different wavelengths. Thus, by filtering certain wavelengths, the window material may make the photovoltaic cell appear non-visible to a user of the portable device by appearing as a solid color and may enhance the cosmetic appearance of the optical receiver or photovoltaic cell.

FIG. 11 illustrates a flowchart of an exemplary method 1100 of wirelessly charging a chargeable device, in accordance with certain embodiments described herein. Although the method 1100 is described herein with reference to the optical charging device 204, 304, 404, 504, 604, 704, or 804 of FIGS. 2-8, a person having ordinary skill in the art will appreciate that the method 1100 may be implemented by other suitable devices and systems. For example, the method 1100 may be performed by the transmitter 104 of FIG. 1. Although the method 1100 is described herein with reference to a particular order, in various embodiments, blocks herein may be performed in a different order, or omitted, and additional blocks may be added.

In an operational block 1110 of the method 1100, a presence of a chargeable device within a charging region of an optical charger is detected. In an operational block 1120 of the method 1100, light is provided to the chargeable device upon detecting the presence of the chargeable device within the charging region, the light provided through an optical casing and an elastomer when the chargeable device is in contact with the elastomer, the optical casing optically coupled to the elastomer, the light sufficient to charge or power the chargeable device and spectrally matched to a bandgap of an optical receiver positioned on the chargeable device.

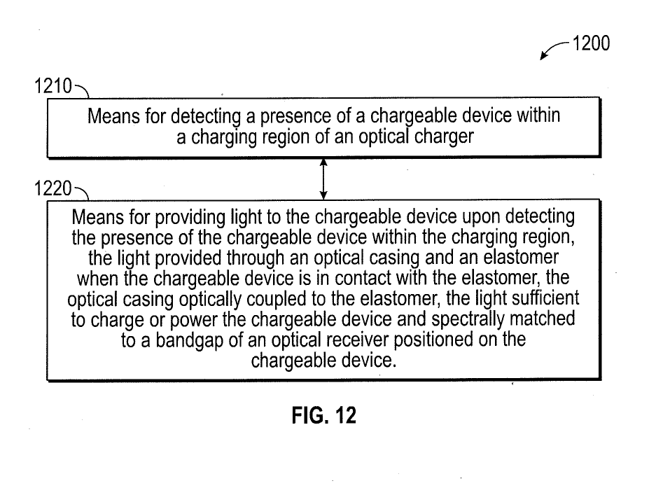

FIG. 12 is a functional block diagram of an apparatus 1200 for providing wireless power, in accordance with certain embodiments described herein. Those skilled in the art will appreciate that the apparatus 1200 may have more components than the simplified block diagrams show in FIG. 12. FIG. 12 includes only those components useful for describing some prominent features of implementations within the scope of the claims.

The apparatus 1200 comprises means 1210 for detecting a presence of a chargeable device within a charging region of an optical charger. In certain embodiments, the means 1210 for detecting can be implemented by the elastomer 520, a pressure sensor, a light sensor, mechanical switch, camera, magnetic sensor, or other detection circuit as described above. In an embodiment, means 1210 for detecting may be configured to perform one or more of the functions discussed above with respect to block 1110. The apparatus 1200 further comprises means 1220 for coupling the providing means with the chargeable device. In certain embodiments, the means 1220 for providing light can be implemented by the optical charging device 204, 304, 404, 504, 604, 704, or 804 of FIGS. 2-8.

The various operations of methods described above may be performed by any suitable means capable of performing the operations, such as various hardware and/or software component(s), circuits, and/or module(s). Generally, any operations illustrated in the Figures may be performed by corresponding functional means capable of performing the operations.

Information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

The various illustrative logical blocks, modules, circuits, and algorithm steps described in connection with the embodiments disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. The described functionality may be implemented in varying ways for each particular application, but such implementation decisions should not be interpreted as causing a departure from the scope of the embodiments of the invention.

The various illustrative blocks, modules, and circuits described in connection with the embodiments disclosed herein may be implemented or performed with a general purpose processor, a Digital Signal Processor (DSP), an Application Specific Integrated Circuit (ASIC), a Field Programmable Gate Array (FPGA) or other programmable logic device, discrete gate or transistor logic, discrete hardware components, or any combination thereof designed to perform the functions described herein. A general purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

The steps of a method or algorithm and functions described in connection with the embodiments disclosed herein may be embodied directly in hardware, in a software module executed by a processor, or in a combination of the two. If implemented in software, the functions may be stored on or transmitted over as one or more instructions or code on a tangible, non-transitory computer-readable medium. A software module may reside in Random Access Memory (RAM), flash memory, Read Only Memory (ROM), Electrically Programmable ROM (EPROM), Electrically Erasable Programmable ROM (EEPROM), registers, hard disk, a removable disk, a CD ROM, or any other form of storage medium known in the art. A storage medium is coupled to the processor such that the processor can read information from, and write information to, the storage medium. In the alternative, the storage medium may be integral to the processor. Disk and disc, as used herein, includes compact disc (CD), laser disc, optical disc, digital versatile disc (DVD), floppy disk and blu ray disc where disks usually reproduce data magnetically, while discs reproduce data optically with lasers. Combinations of the above should also be included within the scope of computer readable media. The processor and the storage medium may reside in an ASIC. The ASIC may reside in a user terminal. In the alternative, the processor and the storage medium may reside as discrete components in a user terminal.

For purposes of summarizing the disclosure, certain aspects, advantages and novel features of the inventions have been described herein. It is to be understood that not necessarily all such advantages may be achieved in accordance with any particular embodiment of the invention. Thus, the invention may be embodied or carried out in a manner that achieves or optimizes one advantage or group of advantages as taught herein without necessarily achieving other advantages as may be taught or suggested herein.

Various modifications of the above described embodiments will be readily apparent, and the generic principles defined herein may be applied to other embodiments without departing from the spirit or scope of the invention. Thus, the present invention is not intended to be limited to the embodiments shown herein but is to be accorded the widest scope consistent with the principles and novel features disclosed herein.

What is claimed is:

1. An optical charger for wirelessly charging a chargeable device, comprising:
a light source configured to provide light to the chargeable device sufficient to charge or power the chargeable device, the light spectrally matched to a bandgap of an optical receiver positioned on the chargeable device;
an optical casing at least partially surrounding the light source; and
an elastomer situated on the optical casing, the elastomer located between the optical casing and the chargeable device when charging.

2. The optical charger of claim 1, wherein the optical casing comprises a material having an index of refraction substantially similar to a material of the elastomer.

3. The optical charger of claim 1, wherein the light source is configured to provide light to the chargeable device through the optical casing and the elastomer when the chargeable device is in contact with the elastomer, the optical casing optically coupled to the elastomer.

4. The optical charger of claim 1, further comprising a detection circuit operably coupled to the light source and configured to detect a presence of the chargeable device within a charging region of the light source, wherein the light source is configured to provide light to the chargeable device upon the detection circuit detecting the presence of the chargeable device within the charging region.

5. The optical charger of claim 4, wherein the detection circuit comprises a sensor configure to measure a shadow of the chargeable device when the chargeable device is placed on a surface of the optical charger.

6. The optical charger of claim 4, wherein the detection circuit comprises a communication antenna configured to transmit a signal to determine a distance between the antenna and the chargeable device.

7. The optical charger of claim 4, wherein the detection circuit comprises:
a camera configured to capture an image; and
a processor configured to detect a presence of a feature of the chargeable device based on the image.

8. The optical charger of claim 7, wherein the feature comprises at least one of a response code, or a physical characteristic, or a pattern displayed on a display of the chargeable device, or any combination thereof.

9. The optical charger of claim 1, further comprising a communication antenna operably coupled to the light source and configured to communicate with the chargeable device, wherein the communication antenna is configured to receive voltage level or charge state information of a battery of the chargeable device; and wherein the light source is further configured to adjust an intensity of the light provided to the chargeable device in response to the voltage level or charge state information.

10. A method for providing wireless power from an optical charger, comprising:
detecting a presence of a chargeable device within a charging region of the optical charger; and
providing light to the chargeable device upon detecting the presence of the chargeable device within the charging region, the light provided through an optical casing and an elastomer when the chargeable device is in contact with the elastomer, the optical casing optically coupled to the elastomer, the light sufficient to charge or power the chargeable device and spectrally matched to a bandgap of an optical receiver positioned on the chargeable device.

11. The method of claim 10, wherein the optical casing comprises a material having an index of refraction substantially similar to a material of the elastomer.

12. The method of claim 10, wherein detecting a presence of the chargeable device comprises measuring a shadow of the chargeable device when the chargeable device is placed on a surface of the optical charger.

13. The method of claim 10, wherein detecting a presence of the chargeable device comprises:
capturing an image; and
detecting a presence of a feature of the chargeable device based on the image.

14. The method of claim 13, wherein the feature comprises at least one of a response code, or a physical characteristic, or a pattern displayed on a display of the chargeable device, or any combination thereof.

15. The method of claim 10, further comprising:
receiving a voltage level or charge state information of a battery of the chargeable device; and
adjusting an intensity of the light provided to the chargeable device in response to the voltage level or charge state information.

16. An apparatus for receiving wireless power, comprising:
a photovoltaic cell configured to receive light from an optical charger, the light spectrally matched to a bandgap of the photovoltaic cell; and
an optical filter coupled to the photovoltaic cell configured to filter wavelengths in a visible spectrum.

17. The apparatus of claim 16, wherein the photovoltaic cell comprises gallium arsenide.

18. The apparatus of claim 16, wherein the optical filter is further configured to:
transmit light in a portion of the optical spectrum spectrally matched to a bandgap of the photovoltaic cell; and
reflect or absorb energy in another portion of the spectrum.

19. The apparatus of claim 16, wherein the optical filter comprises one of gentex filtron, perylene black, cobalt aluminate blue spinel, or cadmium orange.

20. The apparatus of claim 16, wherein the photovoltaic cell is further configured to receive energy from a broadband light source.
